(19) United States
(12) Patent Application Publication
(10) Pub. No.: US 2015/0184820 A1
(43) Pub. Date: Jul. 2, 2015

(54) HEAD LAMP FOR VEHICLE

(71) Applicant: HYUNDAI MOBIS CO., LTD., Seoul (KR)

(72) Inventors: Hyuk Min Lee, Yongin-si (KR); Hyun Soo Lee, Yongin-si (KR); Myoung Guk Bang, Yongin-si (KR); In Heum Park, Yongin-si (KR)

(73) Assignee: HYUNDAI MOBIS CO., LTD., Seoul (KR)

(21) Appl. No.: 14/210,166

(22) Filed: Mar. 13, 2014

(30) Foreign Application Priority Data
Dec. 27, 2013 (KR) 10-2013-0165694

(51) Int. Cl. F21S 8/10; B60Q 1/076

(52) U.S. Cl. CPC F21S 48/1757; B60Q 1/076

(57) ABSTRACT

Provided is a head lamp for a vehicle. The headlamp includes: a reflector which reflects light emitted from a light source; a sliding unit which applies rotational force to the reflector; a first frame which accommodates the reflector; and a second frame which accommodates the first frame, in which the first frame is rotatably connected to the second frame.

### CROSS-REFERENCE TO RELATED APPLICATIONS

This application claims priority to and the benefit of Korean Patent Application No. 10-2013-0165694 filed in the Korean Intellectual Property Office on Dec. 27, 2013, the entire contents of which are incorporated herein by reference.

### FIELD

The present invention relates to a head lamp for a vehicle.

### BACKGROUND

In general, lamps for a vehicle are classified into a head lamp which is installed at a front side of a vehicle, and a tail lamp which is installed at a rear side of the vehicle. The head lamps are mounted at both sides of the front side of the vehicle, and allow a driver to secure a visual field in a driving direction when the vehicle is driven at night.

Recently, the head lamp may be configured to be moved in up and down directions or in left and right directions depending on a driving environment. For example, in a case in which the vehicle moves along a curved road, the head lamp may swivel along the driving direction so as to help the driver secure a visual field. A device, which operates rotation of the head lamp, is illustrated in FIG. 6. Referring to FIG. 6, a head lamp 54 may be rotated about a rotation shaft 55 depending on an operation of a worm gear 52 which is rotated by an electric motor 51, and an operation of a worm wheel 53 which is engaged with the worm gear 52.

However, in the aforementioned structure, there are problems in that rotational force is not sufficiently transmitted due to a backlash, and thus the rotation of the head lamp cannot be controlled precisely.

### SUMMARY

Embodiments of the present invention are directed to a head lamp for a vehicle, in which rotation of the head lamp may be precisely controlled.

An embodiment of the present invention provides a head lamp for a vehicle, including: a reflector which reflects light emitted from a light source; a sliding unit which applies rotational force to the reflector; a first frame which accommodates the reflector; and a second frame which accommodates the first frame, in which the first frame is rotatably connected to the second frame.

The reflector may include an extending portion, the sliding unit may include a rotation shaft, an electric motor which drives the rotation shaft, and a driving unit which is connected to the rotation shaft, and the driving unit may be connected to the extending portion.

The driving unit may further include a connecting projection, and the connecting projection may be fitted into a seating groove that is provided in the extending portion.

The connecting projection may be formed in a cylindrical shape.

A length of the seating groove may be greater than a width of the seating groove.

The reflector may be fixed to the first frame.

The first frame may include a first main body which is formed in a hollow shape, a first connecting portion which extends from the first main body, and a second connecting portion which extends from the first main body at a position opposite to the first connecting portion, and the second frame may include a second main body which is formed in a hollow shape, a third connecting portion which extends from the second main body and is connected to the first connecting portion, and a fourth connecting portion which extends from the second main body at a position opposite to the third connecting portion and is connected to the second connecting portion.

The first connecting portion may be connected to the third connecting portion through a first hinge shaft.

The second connecting portion may be connected to the fourth connecting portion through a second hinge shaft.

The first hinge shaft and the second hinge shaft may form a straight line.

The first hinge shaft and the second hinge shaft may be spaced apart from the extending portion at a predetermined distance.

The head lamp for a vehicle may further include a housing to which the second frame is fixed.

According to the head lamp for a vehicle according to the embodiment of the present invention, a backlash is reduced such that rotation of the head lamp may be precisely controlled.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a front perspective view illustrating a head lamp for a vehicle according to an embodiment of the present invention.

FIG. 2 is a rear perspective view illustrating the head lamp for a vehicle of FIG. 1.

FIG. 3 is a top plan view illustrating the head lamp for a vehicle of FIG. 1.

FIG. 4 is a rear view illustrating the head lamp for a vehicle of FIG. 1.

FIG. 5 is a side view illustrating the head lamp for a vehicle of FIG. 1.

FIG. 6 is a schematic view exemplarily illustrating a connecting structure between an extending portion and a driving unit of FIG. 1.

FIG. 7 is a schematic view for explaining an operation of a head lamp for a vehicle according to the related art.

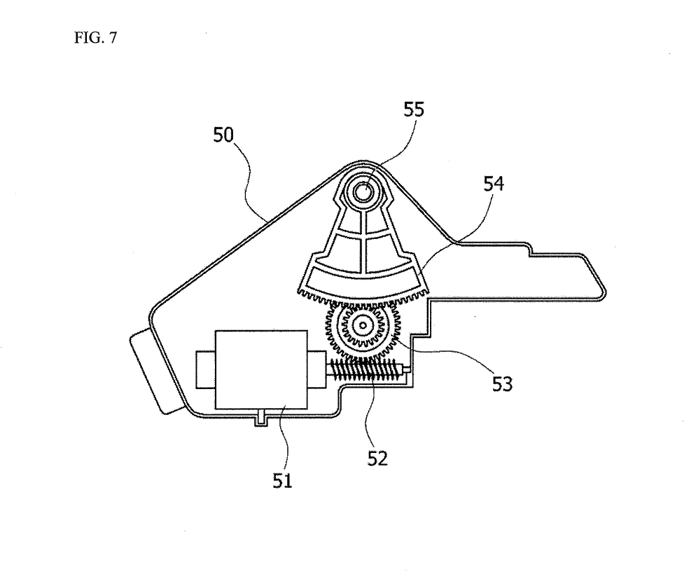

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the drawings. Substantially the same constituent elements are indicated by the same reference numerals in the following description and the accompanying drawings, so that a repeated description will be omitted. In describing the embodiments of the present invention, well-known related functions or configurations will not be described in detail since the detailed description for the well-known related functions or configurations may unnecessarily obscure the understanding of the present invention.

It should be understood that when one constituent element referred to as being “coupled to” or “connected to” another constituent element, one constituent element can be directly coupled to or connected to the other constituent element, but intervening elements may also be present. In contrast, when one constituent element is “directly coupled to” or “directly connected to” another constituent element, it should be understood that there are no intervening elements present.

In the present specification, singular expressions include plurals unless they definitely have opposite meanings. The meaning of “comprises” and/or “comprising” used in this specification does not exclude the existence or addition of aforementioned constituent elements, steps, operations, and/or device, and one or more other constituent elements, steps, operations, and/or devices.

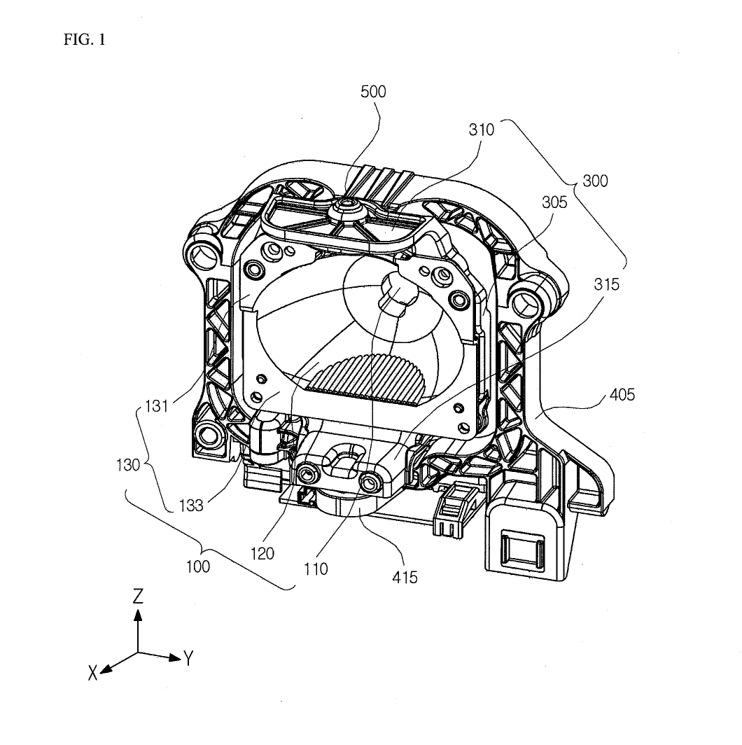

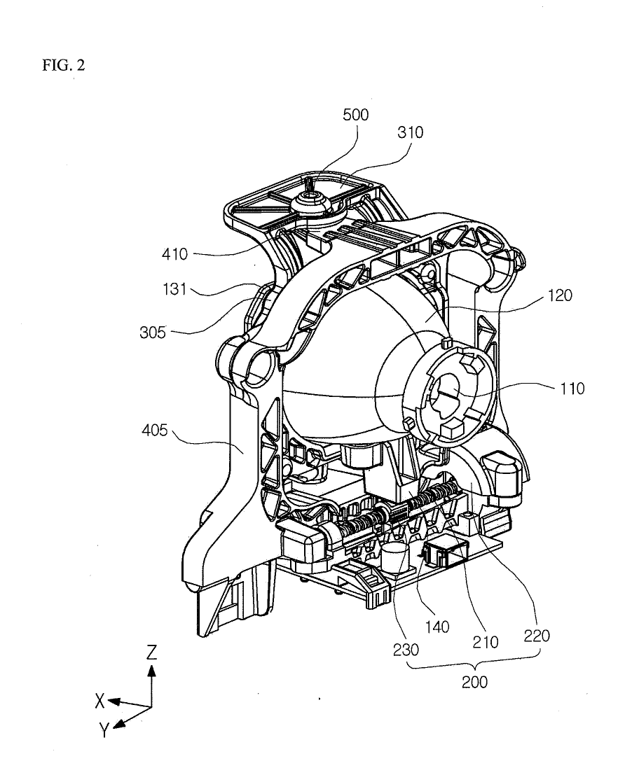

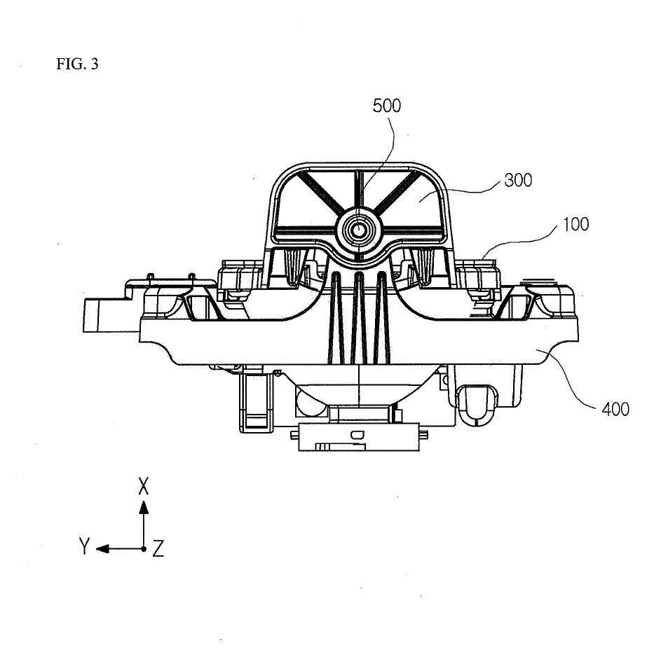

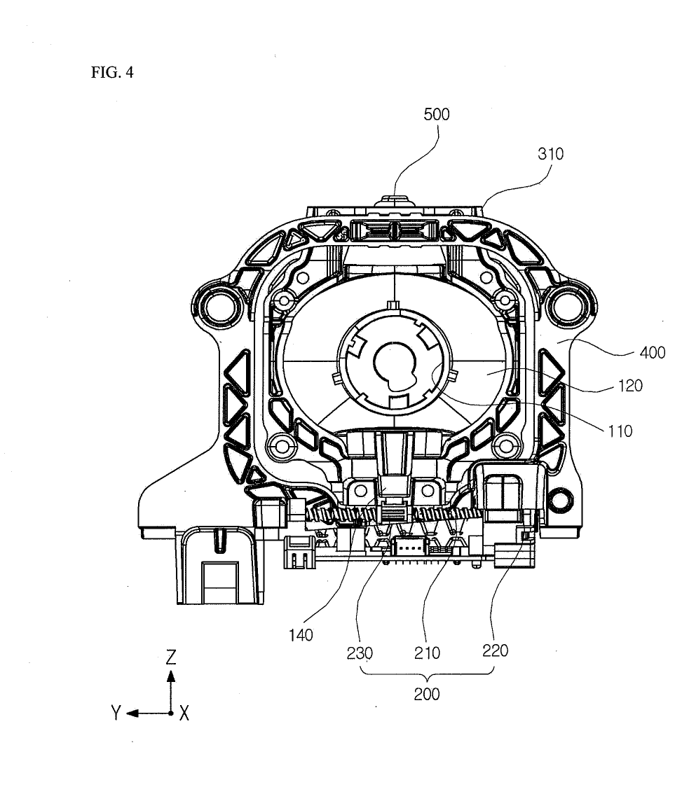

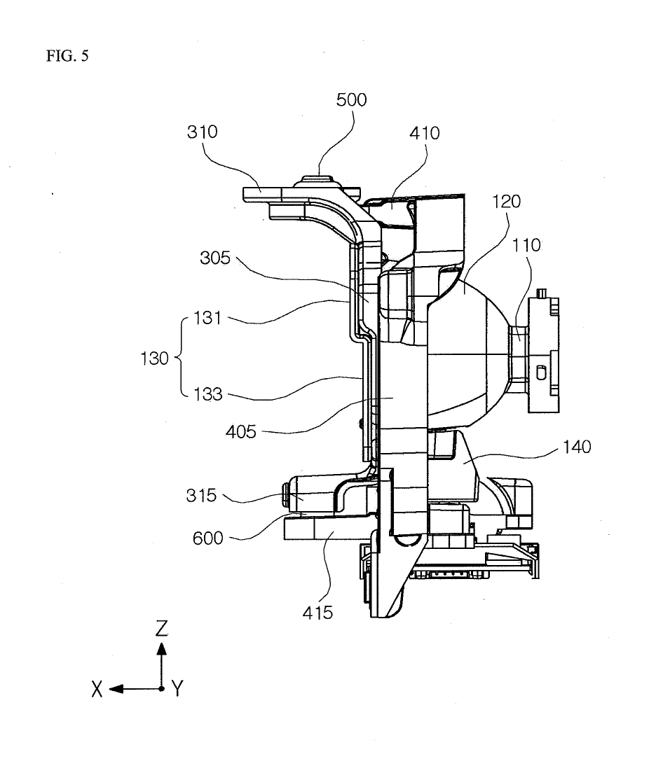

FIG. 1 is a front perspective view illustrating a head lamp for a vehicle according to an embodiment of the present invention, FIG. 2 is a rear perspective view illustrating the head lamp for a vehicle of FIG. 1, FIG. 3 is a top plan view illustrating the head lamp for a vehicle of FIG. 1, FIG. 4 is a rear view illustrating the head lamp for a vehicle of FIG. 1, and FIG. 5 is a side view illustrating the head lamp for a vehicle of FIG. 1.

Referring to FIGS. 1 to 5, a head lamp for a vehicle according to an embodiment of the present invention includes a reflector (or reflector assembly) 100, a sliding unit (or sliding mechanism) 200, a first frame 300, and a second frame 400.

The reflector 100 serves to reflect light emitted from a light source (not illustrated), and includes a light source mounting portion 110, a side wall portion 120, a flange portion 130, and an extending portion 140.

The light source may be mounted on the light source mounting portion 110. For example, the light source mounting portion 110 may be formed in an approximately cylindrical shape. Meanwhile, the light source may be a light emitting diode (LED), or a halogen lamp.

The side wall portion 120 has a predetermined thickness, and extends from the light source mounting portion 110 so as to form an internal space. A cross section of the side wall portion 120 in a lateral direction (in a Y-axis direction in the drawing) is formed in a circular shape, and a diameter of the side wall portion 120 is increased as the side wall portion 120 becomes farther away from the light source mounting portion 110 (toward an X-axis direction in the drawing). Therefore, a cross section of the side wall portion 120 in a longitudinal direction (the X-axis direction in the drawing) is formed in an approximate parabola shape. However, the present invention is not limited thereto, and the reflector may have various shapes as long as the reflector may reflect light emitted from the light source.

The flange portion 130 is a portion that is connected to the first frame 300, and is formed to extend at an edge of the side wall portion 120. For example, the flange portion 130 may be fixed to the first frame 300 by a screw.

Meanwhile, the flange portion 130 may include a first flange portion 131, and a second flange portion 133. The first flange portion 131 and the second flange portion 133 may be provided at positions opposite to each other based on a center of the internal space of the side wall portion 120. A pair of first flange portions 131 may be disposed to be symmetric to each other. Meanwhile, an edge of the second flange portion 133 may have an approximately rectangular shape.

The extending portion 140 is a portion that extends from one side of the side wall portion 120. The extending portion 140 is connected to a driving unit 230 of the sliding unit 200 which will be described below, and thus the sliding unit 200 may apply rotational force to the reflector 100 through the extending portion 140.

The sliding unit 200 is a device that applies a rotational force to the reflector 100. The sliding unit 200 includes a rotation shaft 210, an electric motor 220, and a driving unit 230.

The rotation shaft 210 is formed in a bar shape, and has screw threads formed on an outer circumferential surface of the rotation shaft 210. The electric motor 220 is a device that is connected to the rotation shaft 210 so as to rotate the rotation shaft 210.

The driving unit 230 is connected to the rotation shaft 210, and may be rectilinearly moved depending on the rotation of the rotation shaft 210. For example, the driving unit 230 has screw threads, which are provided on an inner circumferential surface of the driving unit 230 and engaged with the screw threads of the rotation shaft 210, and is connected to the rotation shaft 210. Therefore, when the rotation shaft 210 is rotated, the driving unit 230 may be rectilinearly moved in an axial direction of the rotation shaft 210.

Meanwhile, the driving unit 230 is connected to the extending portion 140 of the reflector 100. Therefore, when the driving unit 230 is rectilinearly moved depending on the rotation of the rotation shaft 210, force is applied to the extending portion 140. However, since the reflector 100 is connected to the first frame 300, the force, which is applied to the reflector 100, is also applied to the first frame 300.

On the other hand, as described below, the first frame 300 is rotatably connected to the second frame 400. As a result, force, which is generated by an operation of the sliding unit 200, is transmitted to the extending portion 140 of the reflector 100 through the driving unit 230, and then transmitted to the first frame 300, such that the first frame 300 is relatively rotated with respect to the second frame 400.

Since the reflector 100 is connected to the first frame 300, the reflector 100 is rotated together with the first frame 300. That is, the extending portion 140 of the reflector 100 is moved along a circle which is centered on a rotation center of the first frame 300. At the same time, the extending portion 140 of the reflector 100 is also moved rectilinearly along the driving unit 230 of the sliding unit 200. Therefore, a connecting structure between the extending portion 140 and the driving unit 230 reflects the aforementioned configuration.

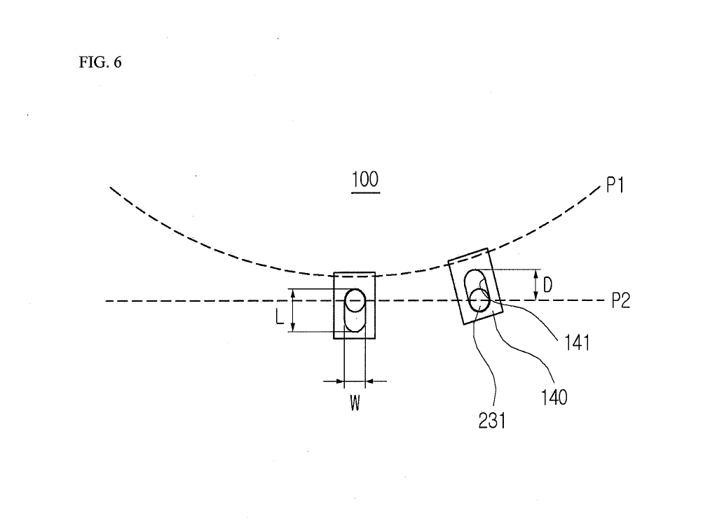

For example, the extending portion 140 and the driving unit 230 may form a structure as illustrated in FIG. 6. Referring to FIG. 6, a seating groove 141 is formed in the extending portion 140, and a connecting projection 231, which is fitted into the seating groove 141, is formed on the driving unit 230. The connecting projection 231 may be formed in a cylindrical shape, and a length L of the seating groove 141 is greater than a width W of the seating groove 141.

As the reflector 100 and the first frame 300 are rotated, a distance between a trajectory P1 that the extending portion 140 follows and a trajectory P2 that the driving unit 230 follows is varied, and the seating groove 141 may absorb a distance variation D. The length L of the seating groove 141 may be formed as a length that may sufficiently absorb the distance variation D.

The first frame 300 accommodates the reflector 100, and is rotatably connected to the second frame 400. The first frame 300 includes a first main body 305, a first connecting portion 310, and a second connecting portion 315.

The first main body 305 may be formed in a hollow shape so as to accommodate the reflector 100. The first flange portion 131 and the second flange portion 133 of the reflector 100 are connected to the first main body 305. For example, the first flange portion 131 and the second flange portion 133 of the reflector 100 may be coupled to the first main body 305 by screws. As such, since the reflector 100 is connected to the first main body 305 of the first frame 300, force, which is applied to the reflector 100 by the sliding unit 200, is also applied to the first frame 300.

The first connecting portion 310 extends from the first main body 305, and the second connecting portion 315 extends from the first main body 305 at a position opposite to the first connecting portion 310. The first connecting portion 310 and the second connecting portion 315 are rotatably connected to the second frame 400.

For example, the first connecting portion 310 may be connected to the second frame 400 through a first hinge shaft 500. Likewise, the second connecting portion 315 may also be connected to the second frame 400 through a second hinge shaft 600. In this case, the first hinge shaft 500 and the second hinge shaft 600 are present on a straight line. Since the first hinge shaft 500 and the second hinge shaft 600 are spaced apart from the extending portion 140 of the reflector 100 at a predetermined distance, when the sliding unit 200 applies force to the extending portion 140, the reflector 100 and the first frame 300 may be rotated about the first hinge shaft 500 and the second hinge shaft 600.

The second frame 400 accommodates the first frame 300, and may be fixed to a housing (not illustrated). The housing is connected to a vehicle body, and thus the second frame 400 is fixed to the housing.

Meanwhile, the second frame 400 includes a second main body 405, a third connecting portion 410, and a fourth connecting portion 415.

The second main body 405 may be formed in a hollow shape so as to accommodate the first frame 300.

The third connecting portion 410 and the fourth connecting portion 415 extend from the second main body 405 at positions opposite to each other. The third connecting portion 410 is connected to the first connecting portion 310 of the first frame 300 through the first hinge shaft 500, and thus the first connecting portion 310 may be relatively rotated with respect to the third connecting portion 410. The fourth connecting portion 415 is connected to the second connecting portion 315 of the first frame 300 through the second hinge shaft 600, and thus the second connecting portion 315 may be relatively rotated with respect to the fourth connecting portion 415.

As described above, according to the head lamp according to the embodiment of the present invention, rotational force, which is generated by the rotation shaft 210 of the sliding unit 200, is directly transmitted to the extending portion 140 of the reflector 100 through the driving unit 230. A backlash may be reduced in this structure, and thus rotational force may be sufficiently transmitted to the reflector 100. Therefore, according to the head lamp according to the embodiment of the present invention, rotation of the head lamp may be precisely controlled.

As described above, the embodiments have been described and illustrated in the drawings and the specification. The embodiments were chosen and described in order to explain certain principles of the invention and their practical application, to thereby enable others skilled in the art to make and utilize various embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A head lamp for a vehicle, comprising:
a reflector configured to reflect light emitted from a light source;
a sliding unit configured to apply a rotational force to the reflector;
a first frame configured to accommodate the reflector; and
a second frame configured to accommodate the first frame, wherein the first frame is rotatably connected to the second frame.

2. The head lamp of claim 1, wherein the reflector includes an extending portion, the sliding unit includes a rotation shaft, an electric motor which drives the rotation shaft, and a driving unit connected to the rotation shaft, and the driving unit is connected to the extending portion.

3. The head lamp of claim 2, wherein the driving unit further includes a connecting projection, and the connecting projection is fitted into a seating groove provided at the extending portion.

4. The head lamp of claim 3, wherein the connecting projection is cylindrical in shape.

5. The head lamp of claim 4, wherein a length of the seating groove is greater than a width of the seating groove.

6. The head lamp of claim 1, wherein the reflector is fixed to the first frame.

7. The head lamp of claim 6, wherein the first frame includes a first main body in a hollow shape, a first connecting portion extending from the first main body, and a second connecting portion extending from the first main body at a position opposite to the first connecting portion, and the second frame includes a second main body in a hollow shape, a third connecting portion extending from the second main body and is connected to the first connecting portion, and a fourth connecting portion extending from the second main body at a position opposite to the third connecting portion and is connected to the second connecting portion.

8. The head lamp of claim 7, wherein the first connecting portion is connected to the third connecting portion through a first hinge shaft.

9. The head lamp of claim 8, wherein the second connecting portion is connected to the fourth connecting portion through a second hinge shaft.

10. The head lamp of claim 9, wherein the first hinge shaft and the second hinge shaft form a straight line.

11. The head lamp of claim 10, wherein the first hinge shaft and the second hinge shaft are spaced apart from the extending portion at a predetermined distance.

12. The head lamp of claim 11, further comprising:
a housing to which the second frame is fixed.

13. A head lamp for a vehicle, comprising:
a light source;
a reflector assembly comprising a reflection surface configured to reflect light emitted from the light source;
a sliding mechanism configured to apply force to the reflector assembly for sliding the reflector assembly along a predetermined trajectory;
a first frame connected to the reflector assembly for holding the reflector assembly; and
a second frame connected to the first frame for holding the first frame while permitting movement of the first frame relative to the second frame, wherein when the sliding mechanism applies force to the reflector assembly for sliding, the first frame and the reflector assembly are to slide together relative to the second frame.

14. A method of operating a head lamp in a vehicle, the method comprising:
providing the head lamp of claim 13; and
applying force to the reflector assembly using the sliding mechanism such that the reflector assembly slides along a predetermined trajectory;
wherein applying force causes the first frame to slide along with the reflector assembly relative to the second frame.
